(19) United States
(12) Patent Application Publication
(10) Pub. No.: US 2015/0184686 A1
(43) Pub. Date: Jul. 2, 2015

(54) BOLT

(71) Applicant: Lock'n Bolt Corporation, Yokohama-shi (JP)

(72) Inventor: Kenji Hasegawa, Yokohama-shi (JP)

(73) Assignee: Lock'n Bolt Corporation, Yokohama-shi (JP)

(21) Appl. No.: 14/569,231

(22) Filed: Dec. 12, 2014

(30) Foreign Application Priority Data
Dec. 27, 2013 (JP) 2013-272083

(51) Int. Cl. F16B 31/02

(52) U.S. Cl. CPC F16B 31/027

(57) ABSTRACT

A bolt capable of fastening without use of a special tool and which is extremely hard to be loosened (detached) after fastening is provided. A bolt of the present invention is configured by a fastened bolt, a fastening bolt, and a lock portion. A first engagement portion is provided on one end of a fastened bolt shank, and a concave portion is provided in the center part of the bolt shank. The fastening bolt has a second engagement portion on the surface confronting the first engagement portion and a fastening shank which is slidably inserted into the concave portion. The bolt is configured so that when the fastening bolt is turned in only one direction, the first engagement portion and the second engagement portion are engaged to turn the fastened bolt, but when the clamp load rotating the fastened bolt in only one direction reaches a predetermined torque, the lower strength portion is damaged so that the clamp load of the fastening bolt is not transferred to the fastened bolt.

### TECHNICAL FIELD

The present invention relates to a bolt which is screwed into clamped components, more particularly relates to a bolt which is extremely hard to be detached from the clamped components after the bolt is once screwed into the clamped components.

### BACKGROUND ART

For example, there have been proposed bolts for attaching a license plate to a vehicle, bolts for attaching a lid upon a U-shaped gutter, and other various types of bolts which are hard to be detached from the clamped components for the purpose of, for example, burglar-proofing after two or more clamped components are fastened. However, all known bolts have merits and demerits, so room for improvement is left.

The present inventors previously proposed the bolts described in PLT (Patent Literature) 1 and PLT 2 as well.

The bolts disclosed in PLT 1 and PLT 2 are configured so that once a fastened bolt and a fastening bolt are fastened, the both bolts cannot be detached from a clamped component as they are, but if the fastening bolt is fastened by a force exceeding a required torque, the bolt shank (shaft) of the fastened bolt may be damaged and the bolts may detach from the clamped component.

### REFERENCE LIST

### Patent Literature

PLT 1: Japanese Patent Publication No. 2009-097707A

PLT 2: Japanese Patent Publication No. 2009-275714A

### SUMMARY OF INVENTION

The present invention provides a bolt which can be easily fastened without using a special tool and which, on the other hand, is extremely hard to be unfastened (detached) after fastening.

### Solution to Problem

According to the present invention, there is provided a bolt provided with a fastened bolt which is screwed into a clamped component, a fastening bolt, and a lock portion, wherein the fastened bolt has a first engagement portion provided on one end of a shank (shaft) of the fastened bolt and has a concave portion provided at the center of the shank of the fastened bolt, the fastening bolt has a second engagement portion provided on a surface confronting (facing) the first engagement portion of the fastened bolt and is provided with a fastening shank which is slidably inserted into the concave portion provided at the center of the shank of the fastened bolt, the lock portion is provided in an end part of the fastening shank and is configured so that the fastening bolt will not detach from the fastened bolt, when turning the fastening bolt in only one direction, the first engagement portion and the second engagement portion are engaged and turn the fastened bolt in only one direction, and when a clamp load that turns the fastened bolt in only one direction reaches a predetermined torque, the clamp load of the fastening bolt is not transferred to the fastened bolt.

Further, according to the present invention, there is provided a bolt provided with a fastened bolt which is screwed into clamped components, a fastening bolt, and a lock portion, wherein the fastened bolt is configured by a fastened bolt shank having a concave portion at the center and a first serration provided on one end of the fastened bolt shank, the fastening bolt is configured by a fastening bolt shank which is slidably inserted into the concave portion provided in the fastened bolt shank and a second serration provided on one end of the fastening bolt shank, the lock portion is provided in an end part of the fastening bolt shank which is positioned on the opposite side to the second serration of the fastening bolt and is configured so that the fastening bolt will not detach from the fastened bolt, a first engagement portion is provided on the top of the first serration, a second engagement portion is provided on a surface of the second serration which confronts (faces) the first serration, the first engagement portion and the second engagement portion are engaged only at the time when the fastening bolt is turned in one direction and thereby turns the fastened bolt in only one direction, and when the first engagement portion and the second engagement portion are engaged and clamp the fastened bolt, when a clamp load that turns the fastened bolt in only one direction reaches a predetermined torque, the clamp load of the fastening bolt is not transferred to the fastened bolt.

### Advantageous Effects of Invention

The bolt of the present invention is configured so that when a pressure of a constant torque or more acts upon a joint (abutment) portion of the first engagement portion of the fastened bolt and the second engagement portion of the fastening bolt, at least one of the engaged portions of the first engagement portion and the second engagement portion is damaged to prevent the turning force of the fastening bolt from being transferred to the fastened bolt, therefore the bolt is extremely difficult to detach from a clamped component, and the bolt has a high safety.

### BRIEF DESCRIPTION OF DRAWINGS

FIGS. 1(A) to (D) are diagrams which show a bolt showing a first embodiment of the present invention.

FIGS. 2(A) to (C) are diagrams which show a bolt showing a second embodiment of the present invention.

FIGS. 3(A) and (B) are enlarged explanatory diagrams which show an engagement state by a first engagement portion of a fastened bolt and a second engagement portion of a fastening bolt.

FIGS. 4(A) to (C) are explanatory diagrams which show a second embodiment of the present invention.

FIG. 5 is an explanatory diagram which shows a third embodiment of the present invention.

FIG. 6 is an explanatory diagram which shows a fourth embodiment of the present invention.

FIG. 7(A) to (C) are explanatory diagrams which shows a fifth embodiment of the present invention.

FIG. 8 is an explanatory diagram which shows a sixth embodiment of the present invention.

FIG. 9 is an explanatory diagram which shows a seventh embodiment of the present invention.

### DESCRIPTION OF EMBODIMENTS

### First Embodiment

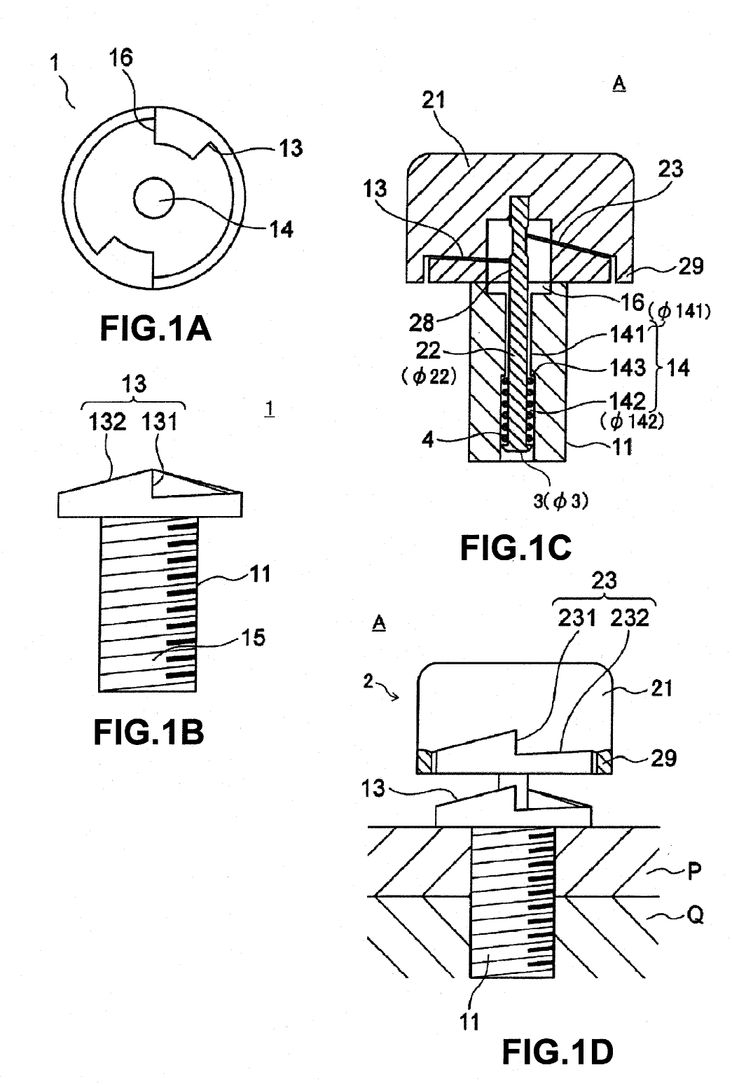

A first embodiment of a bolt of the present invention will be explained in detail with reference to FIGS. 1(A) to (D).

FIG. 1(A) is a top view of a fastened bolt, FIG. 1(B) is a front view of the fastened bolt, FIG. 1(C) is a cross-sectional view of the bolt, and FIG. 1(D) is a partially cutaway side view which shows a state where the bolt is fastened with clamped components.

A bolt A in the first embodiment of the present invention is configured by a fastened bolt 1, a fastening bolt 2, and a lock portion 3 which is provided in a lower end portion of a fastening shank (shaft) 22 of the fastening bolt 2.

As shown in FIG. 1(D), when the fastened bolt 1 is screwed into two clamped components P and Q, and is once clamped by a rotation of the fastening bolt 2 and the resultant rotation of the fastened bolt 1, the two clamped components P and Q are fastened. The fastened bolt 1, as shown in the front view of FIG. 1(B) and cross-sectional view of FIG. 1(C), is configured by a fastened bolt shank 11 and a first engagement portion 13 which is provided on one end of the fastened bolt shank 11. A through-hole is provided as a concave portion 14 in the center part of the fastened bolt shank 11.

The fastening bolt 2 is provided with a head portion 21 and a second engagement portion 23 on a surface confronting the first engagement portion 13 of the fastened bolt 1 and is provided with a fastening shank 22 which is slidably inserted into the concave portion (through-hole) 14 provided in the fastened bolt shank 11.

The lock portion 3, as shown in FIG. 1(C), is provided in a bottom end portion of the fastening shank 22 of the fastening bolt 2 and prevents the detachment of the fastening bolt 2 from the fastened bolt 1.

The fastened bolt 1 is configured by a fastened bolt shank 11 having a concave portion (through-hole) 14 in its center part. A spiral groove 15 is cut in the surface of the fastened bolt shank 11. In the fastened bolt 1, the first engagement portion 13 is formed in the head portion of the fastened bolt shank 11.

In order for the lock portion 3 to prevent the detachment of the fastening bolt 2 from the fastened bolt 1, the concave portion (through-hole) 14 having a diameter (φ14) is configured by a bolt shank insertion hole 141 having a diameter (φ141) having a diameter that is larger than the diameter (φ22) of the fastening shank 22 and is smaller than the diameter (φ3) of the lock portion 3 and by a through-hole 142 which connects with the bolt shank insertion hole 141 and has a larger diameter (φ142) than the diameter (φ3) of the lock portion 3. That is,

φ3>φ141>φ22 and φ142>φ3.

In this way, the size of the aperture (hole) of the concave portion (through-hole) 14 becomes a two-step one of the insertion hole 141 and through-hole 142. The lock portion 3 is configured to be engaged with a stepped part 143 to prevent the lock portion 3 from detachment.

The configuration need only prevent the lock portion 3 from detachment. For example, the stepped part 143 of the concave portion (through-hole) 14 which is provided in the fastened bolt shank 11 may be a simple projection as well.

Notation 4 indicates a spring.

The first engagement portion 13 provided on the surface of the head part of the fastened bolt shank 11 is formed so as to become the engagement portion (exert a locking function (rotation inhibitory function)) at the time of turning in one direction and not become the engagement portion (not exert a locking function (rotation inhibitory function)) at the time of turning in a reverse direction. That is, as shown in FIGS. 1(A) to (D), the first engagement portion 13 is comprised, along the circumference, of a plurality of perpendicularly rising abutting surfaces 131 and a plurality of inclined faces 132 which start from the perpendicularly rising abutting surfaces 131 as vertexes and descend in manner forming wedge-shaped inclined faces of an oblique conical surface and is configured so as to engage with the second engagement portion 23 which is formed in the fastening bolt 2 to turn only in the one direction that clamps the fastened bolt 1 with the clamped components P and Q and to spin idly with respect to a turning force in an opposite direction (direction of loosening the fastening/jointing).

Note that, in the illustration in FIGS. 1(A) to (D), the abutting surfaces 131 of the first engagement portion 13 are provided at two positions.

However, it is sufficient that at least two abutting surfaces 131 be provided along the circumference. They can be designed optionally according to the size of the bolt and so on.

When it is necessary to detach the fastened bolt 1 from the clamped components P and Q, preferably a rotation portion 16 which can be rotated in a direction detaching the fastened bolt 1 is configured in the head part of the fastened bolt 1.

In the illustration in FIGS. 1(A) to (D), the rotation portion 16 is provided on extensions of the abutting surfaces 131 of the first engagement portion 13 as an engagement portion with which a special tool can be engaged. By engagement of a not shown special tool with the rotation portion 16, the fastened bolt 1 can be turned in the opposite direction (direction of loosening) to the direction of fastening the fastened bolt 1, therefore the fastened bolt 1 can be detached from the clamped components P and Q.

Further, the rotation portion 16 can be formed as a polygonal (for example hexagonal) recess or through-hole at the center of the top of the fastened bolt 1. This rotation portion 16 may be structured in any way so far as the fastened bolt 1 can be detached from the clamped components P and Q by attaching a not shown screwdriver or other tool and turning the fastened bolt 1 when the necessity arises of detaching the fastened bolt 1.

Note that, the rotation portion 16 is omitted in a case where it is not necessary to detach the fastened bolt 1.

The fastening bolt 2 is configured by the head portion 21, a fastening shank 22 which is attached to the head portion 21 integrally therewith or detachably therefrom and is slidably inserted into the concave portion 14 provided in the fastened bolt shank 11, and the second engagement portion 23 provided in the head portion 21.

The lock portion 3 is provided on the rear end (bottom end portion) of the fastening shank 22 on the opposite side to the head portion 21 in the fastening bolt 2.

The head portion 21 of the fastening bolt 2 is shaped so that it can turn the fastening bolt 2 by a wrench or the like. For example, making the outer shape of the head portion 21 a hexagon makes it easy to turn the fastening bolt 2. The fastening bolt 2 is turned to clamp (fasten) the fastened bolt 1 with the clamped components P and Q.

Note that, the outer side of the head portion 21 may be formed not in a hexagonal shape, but a circular or spherical shape at the top of which a hexagonal concave portion is formed and the fastening bolt 2 may be turned through the concave portion. In any case, naturally any shape may be employed so far as it has a configuration capable of turning the fastening bolt 2.

The head portion 21 of the fastening bolt 2 is provided with a plurality of parts of the second engagement portion 23 along its circumference.

The second engagement portion 23 is provided on the surface confronting (facing) the first engagement portion 13 and is formed so as to lock the first engagement portion 13 provided in the fastened bolt 1 when abutting against the first engagement portion 13 and to rotate the fastened bolt 1 in only one direction (direction of fastening the bolt).

The second engagement portion 23 is comprised of abutting portions 231 which abut against the abutting surfaces 131 of the first engagement portion 13 and apply a turning (rotation) force in one direction to the abutting surfaces 131 of the first engagement portion 13 and of inclined faces 232 which start from the abutting surfaces 231 as vertexes and descend in manner forming wedge-shaped inclined faces of an oblique conical surface and is configured so as to engage with the first engagement portion 13 when abutting against the engagement portion 13 and turn the fastened bolt 1 in one direction and to spin idly in an opposite direction.

In the first embodiment, the abutting surfaces 231 of the second engagement portion 23 abutting against the first engagement portion 13 are comprised of the abutting portions 231 which apply a turning force in one direction to the abutting surfaces 131 of the first engagement portion 13 and of the inclined faces 232 which start from the abutting surfaces 231 as vertexes and descend in manner forming wedge-shaped inclined faces of an oblique conical surface. However, naturally, the second engagement portion 23 may also be configured by only projections.

The fastening shank 22 is detachably screwed in the head portion 21. The fastening shank 22, as shown in FIG. 1(C), is provided with a tool fixing portion 28 for preventing turning. The tool fixing portion 28 for preventing turning is provided so that the engaged portions of the first engagement portion 13 and the second engagement portion 23 are separated. When a not shown special tool is inserted from a clearance thereof to press against the fastening shank 22, the fastening shank 22 is prevented from rotation.

Note that, it is also possible to omit the fastening shank 22 in a case where the fastening shank 22 can be strongly pressed by a special tool.

The shape of the tool fixing portion 28 may be configured as for example a polygon, may be given a two face-chamfer as illustrated, may be sand blasted or otherwise processed to form surface relief, etc. so that when pressed by a tool, the force of the tool is reliably transferred to the fastening shank 22.

The tool fixing portion 28 can be used even at the time when the fastening shank 22 is screwed to the head portion 21.

The lock portion 3 is attached to a seat portion (bottom end portion) of the fastening shank 22 and prevents the detachment of the fastening bolt 2 from the fastened bolt 1. Accordingly, the lock portion 3 is configured so that the outside diameter has a size small enough to be inserted into the concave portion (through-hole) 14 of the fastened bolt 1 and large enough to be engaged with, for example, the stepped part 143 provided in the concave portion 14.

The lock portion 3 need only perform the role of preventing the fastening bolt 2 from detaching from the fastened bolt 1, therefore it can be formed in a circular, polygonal, rod, or other shape and can be attached to the fastening shank 22 by screwing, welding, bonding by an adhesive, or the like.

The lock portion 3 is positioned inside the concave portion 14. By positioning the lock portion 3 inside the concave portion 14 in this way, the lock portion can be effectively protected from accidents damaging the lock portion 3, therefore this is preferred.

A method for assembly of the fastened bolt 1 and fastening bolt 2 will be explained.

(1) A spring 4 is inserted into the fastening shank 22, then the lock portion 3 is attached to the rear end (bottom end portion) of the fastening shank 22. The attachment may be carried out by either screwing, welding, or adhesion.

(2) Then, the fastening shank 22 is inserted into the concave portion 14 of the fastened bolt 1, the tool fixing portion 28 is nipped and fixed by a special tool according to need, and the fastening shank 22 is screwed into a screw hole provided in the head portion 21, whereby the assembly is ended.

Note that, in the first embodiment, the spring 4 is attached between the lock portion 3 and the stepped part 143 of the concave portion (through-hole) 14. The spring 4 performs the role of making the fastening bolt 2 continuously contact the head portion of the fastened bolt 1. However, when unnecessary, it is also possible to omit the spring 4.

In FIG. 1(A) to (D), the bottom edge (outer circumferential edge portion) 29 of the fastening bolt 2 is extended so as to cover the engaged portions of the first engagement portion 13 of the fastened bolt 1 and the second engagement portion 23 of the fastening bolt 2. By extending the bottom edge 29 of the fastening bolt 2 in this way, the engaged portions of the first engagement portion 13 and the second engagement portion 23 are covered, therefore undesired detachment of the fastened bolt can be made further harder.

As shown in FIG. 1(D), the two clamped components P and Q are connected by the bolt A.

In order to fasten the two clamped components P and Q, at least the first clamped component Q is cut to form a spiral groove which is screwed together with the spiral groove 15 formed in the outer circumference of the fastened bolt shank 11 of the fastened bolt 1. The fastened bolt shank 11 is screwed into the spiral groove. In screwing it in, the fastening bolt 2 is rotated by a not shown hexagonal wrench whereby the second engagement portion 23 engages with the first engagement portion 13 provided in the fastened bolt 1 and the first and second abutting surfaces 131 and 231 face each other to make the fastened bolt 1 turn to screw the fastened bolt 1 into the spiral groove of the clamped component (P) Q to fasten the two clamped components P and Q.

After the two clamped components P and Q are once screwed by the fastened bolt 1 of the bolt A in the first embodiment, even if the fastening bolt 2 is rotated in a detachment direction (reverse direction to the fastening) so as to release this connection (fastening), the abutting surfaces of the first engagement portion 13 and the second engagement portion 23 do not abut against each other and the first inclined face 132 and the second inclined face 232 slide, so the first engagement portion 13 and second engagement portion 23 spin idly. Therefore, the turning force of the fastening bolt 2 is not applied to the fastened bolt 1, thus rotation in the direction detaching the fastened bolt 1 does not occur. Accordingly, once it is fastened, the bolt A cannot be detached as is.

### Second Embodiment

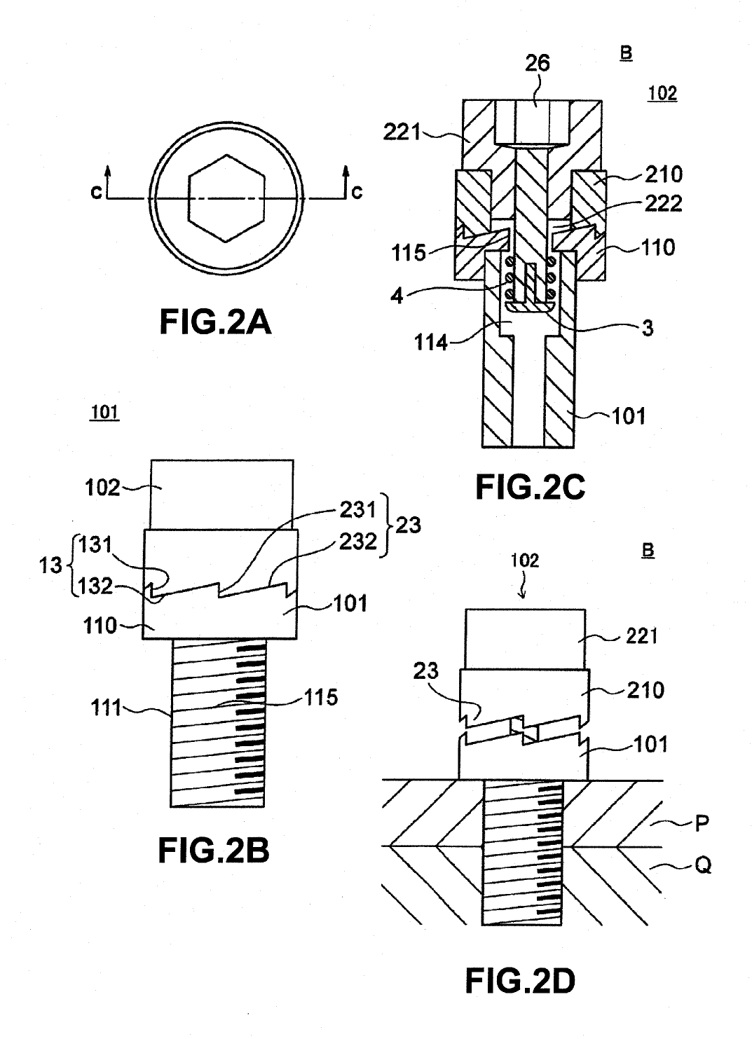

A second embodiment of the bolt in the present invention will be explained in detail with reference to FIGS. 2(A) to (D).

FIG. 2(A) is a top view of a bolt B in the second embodiment, FIG. 2(B) is a front view of the bolt B, FIG. 2(C) is a cross-sectional view of the bolt B, and FIG. 2(D) is a partially cutaway side view which shows a state where the bolt B is fastened with the clamped components.

The bolt B in the second embodiment of the present invention is configured by a fastened bolt 101, a fastening bolt 102, and a lock portion 3. The fastened bolt 101 is screwed together with two clamped components P and Q as shown in FIG. 2(D).

Note that, below, sometimes parts the same as the first embodiment will be assigned the same reference notations and explanations thereof will be omitted.

The fastened bolt 101, as shown in the front view of FIG. 2(B) and cross-sectional view of FIG. 2(C), is configured by a fastened bolt shank 111, a first serration 110 which is provided on one end of this fastened bolt shank 111, and a first engagement portion 13 which is provided in the first serration 110. In the center part of the fastened bolt shank 111, a recessed part is provided as the concave portion 114, or a through-hole is provided as illustrated.

The fastening bolt 102 is provided with a head portion 221 and a second serration 210 on the surface which confronts (faces) the first engagement portion 13 of the fastened bolt 101.

On the surface of the second serration 210, a second engagement portion 23 is provided. Further a fastening shank 222 which is slidably inserted into the concave portion 114 provided in the fastened bolt shank 111 is provided.

The lock portion 3 is provided in the bottom end portion of the fastening bolt 102 as shown in FIG. 2(C) and is attached so that the fastening bolt 102 will not detach from the fastened bolt 101.

In order to prevent the fastening bolt from detachment from the fastened bolt, the fastened bolt 101 is configured by a fastened bolt shank 111 having a concave portion (recess) 114 in its center part. At the outer surface of the fastened bolt shank 111, a spiral groove 115 is cut. In the fastened bolt 101, the first serration 110 is attached to the head portion of the fastened bolt shank 111 by welding, an adhesive, or the like. At the surface of the first serration 110, the first engagement portion 13 is formed. The diameter of the concave portion (recess) 114 is larger than the diameter of the fastening shank 222 and is larger than the diameter of the lock portion 3. As a result, an opening 115 of the recess 114 having an inside diameter of a size large enough to allow the fastened bolt shank 111 to slidably move and small enough to prevent the lock portion 3 from detachment is provided in the first serration 110. By closing this opening by the first serration 110, the lock portion 3 is prevented from detachment.

Note that, naturally the opening 115 of the concave portion (recess) 114 need only be configured so that the lock portion 3 is engaged and is prevented from detachment.

Notation 4 indicates a spring.

The first engagement portion 13 provided on the surface of the first serration 110 of the fastened bolt shank 111 is formed so as to become the engagement portion (exert a locking function (rotation inhibitory function)) at the time of turning in one direction and not become the engagement portion (not exert a locking function (rotation inhibitory function)) at the time of turning in a reverse direction. That is, as shown in FIGS. 2(A) to (D), the first engagement portion 13 is comprised of a plurality of perpendicularly rising abutting surfaces 131 and a plurality of inclined faces 132 which start from the perpendicularly rising abutting surfaces 131 as vertexes and descend in manner forming wedge-shaped inclined faces of an oblique conical surface and is configured so as to engage with the second engagement portion 23 which is formed in the fastening bolt 102 to turn only in the one direction that fastens the clamped components P and Q and to spin idly with respect to a turning force in an opposite direction (direction of loosening the fastening/jointing).

Note that, in the illustration in FIGS. 2(A) to (D), the abutting surfaces 131 of the first engagement portion 13 are provided at six positions. However, it is sufficient that at least two abutting surfaces 131 be provided along the circumference. They can be designed optionally according to the size of the bolt and so on.

It is also possible to configure the opening 115 of the first serration 110 of the fastened bolt 101 as a polygonal rotation portion according to need. This opening (rotation portion) is configured so that when a need arises for detaching the fastened bolt 101, a not shown tool can be inserted and the fastened bolt 101 can be turned to detach the fastened bolt 101. In a fastened bolt which does not have to be detached, it is preferably formed in a circular shape.

The fastening bolt 102 is configured by the head portion 221, the fastening shank 222 which is attached to this head portion 221 integrally therewith or detachably therefrom and is slidably inserted into the concave portion 114 provided in the fastened bolt shank 111, and the second serration 210 which is provided in the head portion 221. The second engagement portion 23 is provided on the surface of the second serration 210.

The lock portion 3 is provided on the rear end (bottom end portion) of the fastening shank 222 on the side opposite to the head portion 221 in the fastening bolt 102.

The head portion 221 of the fastening bolt 102 is shaped so that the fastening bolt 102 can be rotated by a wrench or the like. For example, making the outer shape of the head portion 221 a hexagon makes it easy to turn the fastening bolt 102. The fastening bolt 102 is turned to fasten the fastened bolt 101 with the clamped components P and Q.

The outer side of the head portion 221 may be formed not in a hexagonal shape, but a circular or spherical shape at the top of which a hexagonal concave portion 26 is formed and the fastening bolt 102 may be turned through the concave portion 26.

In any case, naturally any shape may be employed so far as it has a configuration capable of turning the fastening bolt 102.

The second serration 210 is fixed to the head portion 221 of the fastening bolt 102 by welding, an adhesive, or the like, and the second engagement portion 23 is provided on the surface of the second serration.

The second engagement portion 23 is provided on the surface confronting (facing) the first engagement portion 13 and is formed so that it is locked (engaged) with the first engagement portion 13 and is formed so as to lock the first engagement portion 13 provided in the fastened bolt 101 to turn the fastened bolt 101 in only one direction (direction of fastening the bolt).

The second engagement portion 23 is comprised of abutting portions 231 which abut against the abutting surfaces 131 of the first engagement portion 13 and apply a turning force in one direction to the abutting surfaces 131 of the first engagement portion 13 and of inclined faces 232 which start from the abutting surfaces 231 as vertexes and descend in manner forming wedge-shaped inclined faces of an oblique conical surface and is configured so as to engage with the first engagement portion 13 and turn the fastened bolt 101 in one direction and to spin idly in an opposite direction.

The abutting surfaces 231 of the second engagement portion 23 abutting against the first engagement portion 13 are comprised of the abutting portions 231 which apply a turning force in one direction to the abutting surfaces 131 of the first engagement portion 13 and of the inclined faces 232 which start from the abutting surfaces 231 as vertexes and descend in manner forming wedge-shaped inclined faces of an oblique conical surface. However, naturally, the second engagement portion 23 may also be configured by only projections.

In the illustration in FIGS. 2(A) to (D), the fastening shank 222 is formed integrally with the head portion 221. However, it may be formed separate from the head portion 221 and joined by screwing it in or the like.

The lock portion 3 is attached to the seat portion (bottom end portion) of the fastening shank 222 and prevents the fastening bolt 102 from detachment from the fastened bolt 101. Accordingly, the lock portion 3 is configured as a size small enough to be inserted into the concave portion (recess) 114 of the fastened bolt 101 and large enough to be locked by the opening (recess lid 115) of the second serration covering the concave portion 114.

The lock portion 3 need only perform the role of preventing the fastening bolt 102 from detaching from the fastened bolt 101, therefore it can be formed in a circular, polygonal, rod, or other shape and can be attached to the fastening shank 222 by screwing, welding, bonding by an adhesive, or the like.

By positioning the lock portion 3 inside the concave portion 114, the lock portion can be effectively protected from accidents damaging the lock portion 3.

The assembly of the fastened bolt 101 and fastening bolt 102 will be explained.

(1) The second serration 210 is fixed to the head portion 221 having the fastening shank 222 by welding or an adhesive.

(2) Next, the first serration 110 and spring 4 are inserted along the fastening shank 222, and the lock portion 3 is fixed to the seat portion of the fastening shank 222 by screwing, welding, or an adhesive.

(3) Further, the first serration 110 is fixed to the fastened bolt shank 111 by welding or an adhesive, whereby the assembly is ended.

Preferably, the spring 4 is loaded between the lock portion 3 and the first serration 110. The spring 4 performs the role of making the fastening bolt 102 continuously contact the head portion of the fastened bolt 101. However, if this is not necessary, it is also possible to omit the spring 4.

As shown in FIG. 2(D), the two clamped components P and Q are connected by the bolt B.

In order to fasten the two clamped components P and Q, at least the first clamped component Q is cut to form a spiral groove which is screwed together with the spiral groove 115 of the fastened bolt 101. The fastened bolt 101 is screwed into that spiral groove. In screwing the fastened bolt 101 in, a not shown hexagonal wrench is inserted into the rotation portion 26 of, for example, the hexagonal groove provided in the head portion of the fastening bolt 102 and turned, whereby the second engagement portion 23 engages with the first engagement portion 13 provided in the fastened bolt 101 and makes the fastened bolt 101 turn to screw the fastened bolt 101 into the spiral groove of the clamped component (P,) Q, and thereby fasten the two clamped components P and Q.

After the two clamped components P and Q are once screwed by the fastened bolt 101, even if the fastening bolt 102 is rotated in a detachment direction (reverse direction to the fastening) so as to release this connection (fastening), the first engagement portion 13 and the second engagement portion 23 do not abut against each other and the first engagement portion 13 and second engagement portion 23 spin idly. Therefore, the turning force of the fastening bolt 102 is not applied to the fastened bolt 101, thus rotation in the direction detaching the fastened bolt 101 does not occur.

Accordingly, once it is fastened, the bolt B cannot be detached as is from the clamped components.

Where it is necessary to detach the fastened bolt 101, a rotation portion 16 which can be rotated in the direction detaching the fastened bolt 101 is formed at the first serration 110 of the head portion of the fastened bolt 101. The rotation portion may be formed in the same way as in the configuration of the rotation portion 16 which was explained in the first embodiment, so a detailed explanation will be omitted.

In this regard, when the fastening bolt 2 or 102 is made to turn by a torque more than the required level in order to detach the bolt A or B with which the clamped components P and Q are screwed due to an undesired action, for example, for the purpose of theft, there is possibility that the fastened bolt shank 11 or 111 of the fastened bolt 1 or 101 will be damaged and fastened state of the clamped components P and Q will be released.

The second embodiment of the present invention solves such an inconvenience. That is, in the bolts A and B in the second embodiment of the present invention, when the fastening bolt 2 or 102 (2/102) is turned in only one direction, the first engagement portion 13 and the second engagement portion 23 abut against (are engaged) with each other to turn the fastened bolt in only one direction, but the engaged portions of the second engagement portion 23 and the first engagement portion 13 are configured so that, when the clamp load by the fastening bolt 2/102 that turns the fastened bolt 1/101 in only one direction reaches a predetermined torque or more, the clamp load of the fastening bolt 2/102 is not transferred to the fastened bolt.

Below, the configuration of the engaged portions of the second engagement portion 23 and the first engagement portion 13 by which the clamp load of the fastening bolt 2/102 is not transferred to the fastened bolt when the clamp load that turns the fastened bolt 1/101 in only one direction reaches a predetermined torque or more will be explained in detail.

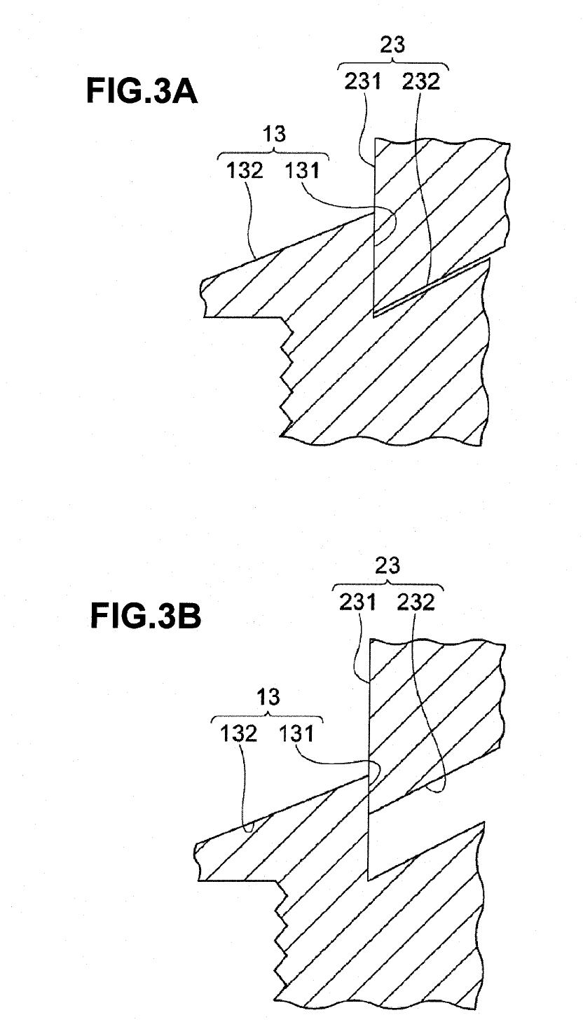

FIGS. 3(A) and (B) are enlarged explanatory diagrams which show the engaged portions of the first engagement portion 13 and second engagement portion 23.

In ordinary engaged portions, the first engagement portion 13 and the second engagement portion 23 are engaged with a sufficient area as shown in FIG. 3(A). However, when they are engaged with a sufficient area in this way, the engagement between the first engagement portion 13 and the second engagement portion 23 is not destroyed even when the clamp load that turns the fastened bolt becomes a predetermined torque or more, therefore an excessive pressure will be exerted upon the fastened bolt shank 11 or 111 (11/111), so there is a possibility of damaging the fastened bolt shank (11/111).

The first aspect of the bolt of the present invention configured so that the clamp (fasten) load of the fastening bolt is not transferred to the fastened bolt when the clamp load reaches a predetermined torque or more is designed as shown in FIG. 3(B) so that the engaged portions of the first engagement portion 13 and second engagement portion 23 are made shallow (small) so that either the first engagement portion 13 or second engagement portion 23 is destroyed if the clamp load that turns the fastened bolt 1 applied to the engaged portions of the two becomes a predetermined torque or more and thereby prevents excessive pressure from being exerted upon the fastened bolt shank (11/111).

By making the engagement of the engaged portions shallow (small) in this way, the clamp load of the fastening bolt is not applied to the fastened bolt 1/101, therefore an undesired action, for example, theft of a clamped component, can be prevented.

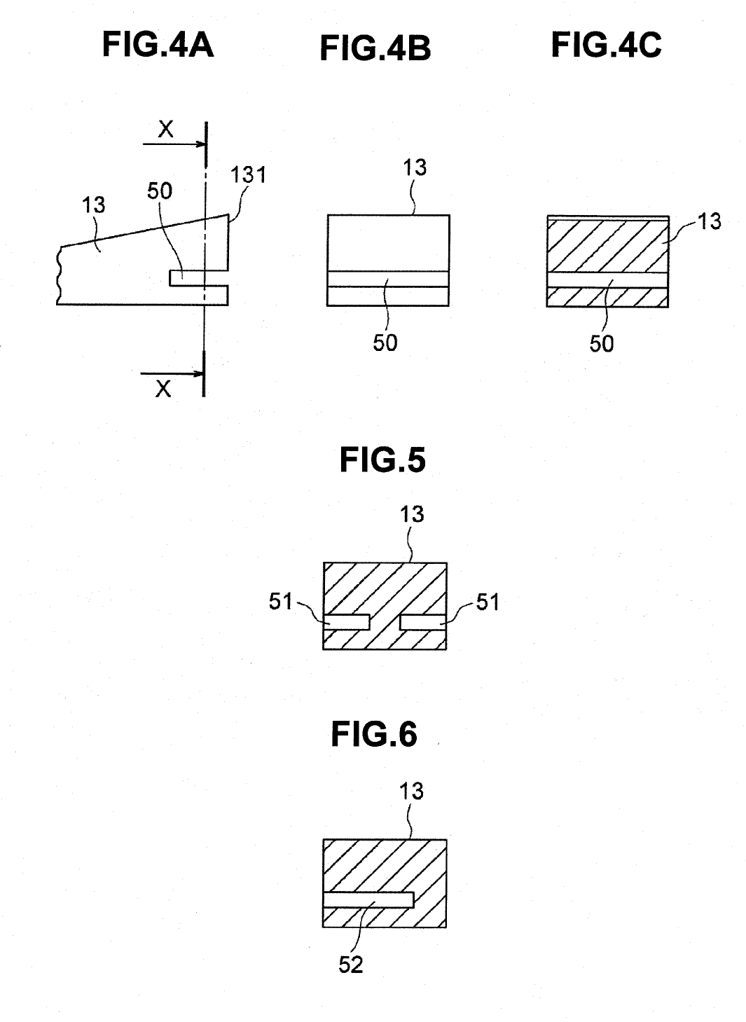

FIGS. 4(A) to (C) to FIG. 9 show the structure of the first engagement portion 13. This is configured so that the first engagement portion 13 is made to engage with a not shown second engagement portion 23 and so that the first engagement portion 13 breaks if a clamp (fasten) load that turns the fastened bolt having a predetermined torque or more is applied to the engaged portions and thereby prevents excessive pressure from being exerted upon the fastened bolt shank.

This will be explained in detail below.

Note that, in the following embodiments, embodiments directly providing the first engagement portion 13 in the fastened bolt shank 11 (see for example FIGS. 1) will be explained in detail, but the invention also applies to embodiments providing the first engagement portion 13 at the first serration 110 in the same way.

FIGS. 4(A) to (C) show a second aspect of the bolt of the present invention configured so that the clamp load of the fastening bolt is not transferred to the fastened bolt if the clamp load reaches a predetermined torque or more, in which FIG. 4(A) is a front view, FIG. 4(B) is a right side view, and FIG. 4(C) is a cross-sectional view taken along an X-X line in FIG. 4(A).

As shown in FIGS. 4, a notch 50 is provided in the engaged portion of the first engagement portion 13 in a direction perpendicular to the fastened bolt shank 11. This notch 50 is configured (designed) so that, when the clamp load that turns the fastened bolt 1 in only one direction reaches a predetermined torque or more, the engaged (vicinity of the vertex) portion of the first engagement portion 13 is damaged along the notch or in a portion where the strength falls due to the notch, and thus the engaged portion is damaged with a predetermined pressure so that the clamp load of the fastening bolt 2 is not transferred to the fastened bolt 1.

### Third Embodiment

In a third embodiment shown in FIG. 5, grooves 51 and 52 are provided in place of the notch 50.

### Fourth Embodiment

In a fourth embodiment shown in FIG. 6, a groove 52 is provided from one side.

Note that, in the second embodiment illustrated in FIGS. 4(A) to (C) or the third embodiment, the depth, width, etc. of the notch or groove are designed so that the engaged portion is damaged with a predetermined pressure considering the size (thickness) etc. of the bolt so that the engaged portion of the engagement portion is damaged when a clamp load that turns the fastened bolt 1 in only one direction reaches a predetermined torque or more and thereby prevents the clamp load of the fastening bolt 2 from being transferred to the fastened bolt 1.

In the following embodiments as well, the design matters (the idea of design so that the engaged portion is damaged with a predetermined pressure considering the size (thickness) etc. of the bolt so that excessive clamp load of the fastening bolt 2 is not transferred to the fastened bolt 1) are the same.

### Fifth Embodiment

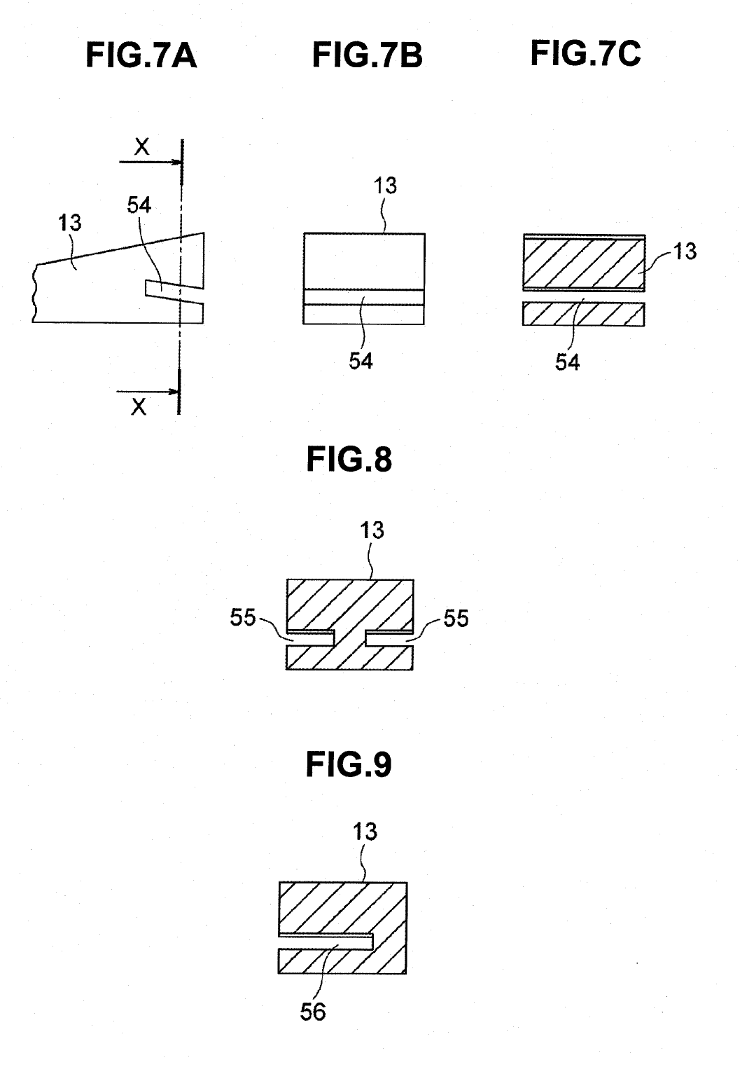

FIGS. 7(A) to (C) illustrate a fifth embodiment of the present invention, in which FIG. 7(A) is a front view, FIG. 7(B) is a right side view, and FIG. 7(C) is a cross-sectional view taken along an X-X line in FIG. 7(A).

The engaged portion of the first engagement portion 13 is provided with a notch 54 in a direction having a constant angle relative to the fastened bolt shank 11. This notch 54 is configured (designed) so that the engaged portion is damaged with a predetermined pressure so that, when the clamp load that turns the fastened bolt 1 in only one direction reaches a predetermined torque or more, the engaged (vicinity of the vertex) portion of the first engagement portion 13 is damaged along the notch or in a portion where the strength falls due to the notch and thereby prevents the clamp load of the fastening bolt 2 from being transferred to the fastened bolt 1.

The reason for provision of the notch 54 in the engaged portion of the first engagement portion 13 in a direction having a constant angle relative to the fastened bolt shank 11 is that, when the clamp load for the fastened bolt 1 applied to this notch 54 reaches a predetermined torque or more and the engaged (vicinity of the vertex) portion of the first engagement portion 13 is damaged along the notch, that damaged cross-section becomes an inclined face and ends up becoming a broken surface from which the engagement with the second engagement portion 23 is released.

### Sixth Embodiment

In a sixth embodiment shown in FIG. 8, grooves 55 and 55 are provided in place of the notch 54.

### Seventh Embodiment

In a seventh embodiment shown in FIG. 9, a groove 56 is provided from one side.

In the embodiments described before, the first engagement portion and second engagement portion were provided with notches and otherwise modified. However, as shown in FIGS. 2(A) to (D), when the fastened bolt 101 is formed by joining the separately formed first serration 110 (first engagement portion 13) and fastened bolt shank 111, it is also possible to adjust the joint strength so that when the clamp load of the fastening bolt 102 exceeds a predetermined pressure, the joint between the first serration 110 and the bolt shank 111 of the fastened bolt 101 will be separated and therefore the clamp load of the fastening bolt 102 will not be transferred to the fastened bolt 101.

For the adjustment of the joint strength, the method of adjusting the strength of the weld or strength of the adhesive, adjusting the area of the welded surface or adjusting the bonded area, or the like can be employed.

Even when the head portion 221 of the fastening bolt 102 and the second serration (second engagement portion 23) 210 are formed separately and then joined, the technical idea of their being configured so that the joint is separated by a constant pressure is the same as described above.

In the embodiments explained above, the example of making the fastened bolt 1 and fastening bolt 2 the above explained shapes and configuring the fastened bolt 1 and fastening bolt 2 by the same grade of material (material), for example, iron, stainless steel (SUS), or the like, was shown. However, it is also possible to configure (form) the fastened bolt 1 and the fastening bolt 2 by grades of material (materials) having different strengths (toughnesses).

That is, a material whereby the strength of the fastened bolt 1, particularly the strength of the first engagement portion 13, becomes stronger than the strength of the second engagement portion 23 of the fastening bolt 2 is selected. The bolt is configured (formed) so that, when the fastened bolt 1 is fastened by the fastening bolt 2, when the clamp load of the fastening bolt 2 exceeds a predetermined pressure, the second engagement portion 23 of the fastening bolt 2 is damaged so as to prevent the clamp load of the fastening bolt 2 from being transferred to the fastened bolt 1. For this purpose, for example, the fastening bolt 2 is configured by a material which is weaker than the strength of the fastened bolt 1, for example, brass, aluminum, or the like, and the fastened bolt 1 is configured (formed) by a material having a high strength, for example, SS or SUS material.

Alternatively, the fastened bolt 1 can be configured by a material of an alloy composition with a high strength, and the fastening bolt 2 can be configured (formed) by a material of an alloy composition with a weak strength.

The embodiments of the present invention have the following characterizing features as explained above.

(1) A bolt in which the concave portion 14 provided in the fastened bolt shank 11 is a through-hole provided in the fastened bolt shank 11.

(2) A bolt in which the concave portion 14 provided in the fastened bolt shank 11 is a recess (concave portion) formed by digging into a portion of the fastened bolt shank 11.

(3) A bolt in which the concave portion 14 provided in the fastened bolt shank 11 has a locking projection for locking the lock portion 3.

(4) A bolt in which the fastened bolt 1 has the first engagement portion 13 and the fastened bolt shank 11 integrally formed.

(5) A bolt in which the fastening bolt 2 has the second engagement portion 23 and the head portion 21 integrally formed.

(6) A bolt in which the fastened bolt 1 has the first engagement portion 13 and the fastened bolt shank 11 formed as different shapes and joined.

(7) A bolt in which the fastening bolt 2 has the second engagement portions 23 and the head portion 21 formed as different shapes and joined.

(8) A bolt in which a convex portion of the first engagement portion 13 which is provided at the fastened bolt 1 and which engages with the second engagement portion 23 is provided with a notch due to which the convex portion is destroyed when a predetermined torque (pressure) is applied to the convex portion and in which when the second engagement portion 23 is engaged with the first engagement portion 13 and the clamp load that turns the fastened bolt 1 in only one direction reaches a predetermined torque, the convex portion is destroyed due to the clamp load of the fastening bolt 2 so that the pressure of the fastening bolt 2 is not transferred to the fastened bolt 1.

(9) A bolt in which a convex portion of the second engagement portion 23 which is provided at the fastening bolt 2 and which engages with the first engagement portion 13 is provided with a notch due to which the convex portion is destroyed when a predetermined torque (pressure) is applied to the convex portion and in which when the second engagement portion 23 is engaged with the first engagement portion 13 and the clamp load that turns the fastened bolt 1 in only one direction reaches a predetermined torque, the convex portion is destroyed due to the clamp load of the fastening bolt 2 so that the pressure of the fastening bolt 2 is not transferred to the fastened bolt 1.

(10) A bolt in which a convex portion of the first engagement portion 13 which is provided at the fastened bolt 1 and which engages with the second engagement portion 23 is provided with a notch due to which the convex portion is destroyed when a predetermined torque (pressure) is applied to the convex portion, in which a convex portion of the second engagement portion 23 which is provided at the fastening bolt 2 and which engages with the first engagement portion 13 is provided with a notch due to which the convex portion is destroyed when a predetermined torque (pressure) is applied to the convex portion, and in which when the second engagement portion 23 is engaged with the first engagement portion 13 and the clamp load that turns the fastened bolt 1 in only one direction reaches a predetermined torque, the convex portions are destroyed due to the clamp load of the fastening bolt 2 so that the pressure of the fastening bolt 2 is not transferred to the fastened bolt 1.

(11) Preferably, a bolt in which a collar is applied to at least the head portion of the fastening bolt 2.

While the invention has been described with reference to specific embodiments chosen for purpose of illustration, it should be apparent that numerous modifications could be made thereto by those skilled in the art without departing from the basic concept and scope of the invention.

### REFERENCE SIGNS LIST

A, B bolt
1 fastened bolt,

11 fastened bolt shank,

13 first engagement portion,

14, 114 concave portions

101 fastened bolt,

102 fastening bolt

110 first serration,

111 fastened bolt shank

131 abutting surface of first engagement portion,

132 inclined face of first engagement portion
2 fastening bolt

21 head portion,

22 fastening shank,

23 second engagement portion

210 second serration,

221 head portion

222 fastening shank,

231 abutting surface of second engagement portion

232 inclined face of second engagement portion
3, 103 lock portions,
4, 104 springs,
50, 54, 57 to 60, 62, 63, 66 notches
51, 52, 55, 56, 61, 65 grooves
68, 70 to 73, 75 to 79, 81, 82 notches
91, 93, 94 square projection portions
92, 95 notches

1. A bolt comprising:
a fastened bolt which is screwed into clamped components;
a fastening bolt; and
a lock portion, wherein the fastened bolt has a first engagement portion provided on one end of the shank of the fastened bolt and has a concave portion provided at the center of the shank of the fastened bolt,
the fastening bolt has a second engagement portion provided on a surface confronting (facing) the first engagement portion of the fastened bolt and is provided with a fastening shank which is slidably inserted into the concave portion provided at the center of the shank of the fastened bolt, and
the lock portion is provided in an end part of the fastening shank and is configured so that the fastening bolt will not detach from the fastened bolt, and
wherein when turning the fastening bolt in only one direction, the first engagement portion and the second engagement portion are engaged and turn the fastened bolt in only one direction, and
when a clamp load that turns the fastened bolt in only one direction reaches a predetermined torque, the clamp load of the fastening bolt is not transferred to the fastened bolt.

2. A bolt as set forth in claim 1, wherein:
the first engagement portion has a first abutting surface and a first inclined face,
the second engagement portion has a second abutting surface and a second inclined face,
wherein, when the fastening bolt is turned in one direction, the first abutting surface and the second abutting surface abut against each other to stop the turning of the fastening bolt in that one direction, and
wherein when the fastening bolt is turned in the other direction, the first inclined face and the second inclined face slidingly move to allow the turning of the fastening bolt in the other direction.

3. A bolt as set forth in claim 2, wherein:
engaged portions of the first engagement portion and the second engagement portion are configured shallow, and
when a clamp load that turns the fastened bolt becomes a predetermined torque or more at the engagement portions, at least a portion of the first engagement portion and/or the second engagement portion is destroyed.

4. A bolt as set forth in claim 2, wherein:
a notch or groove is provided in the engaged portions of the first engagement portion and the second engagement portion in a direction perpendicular to the fastened bolt shank, and
when a clamp load that turns the fastened bolt in only one direction becomes a predetermined torque or more, the part of the first engagement portion which is engaged with the second engagement portion is destroyed along the notch or groove or in a portion of the first engagement portion where the strength falls due to the notch or groove.

5. A bolt as set forth in claim 1, wherein the concave portion (through-hole) is configured by a bolt shank insertion hole having a diameter (φ141) such that the diameter (φ14) of the concave portion (through-hole) is larger than the diameter (φ22) of the fastening shank and smaller than the diameter (φ3) of the lock portion, and
a through-hole which connects with the bolt shank insertion hole and has a diameter (φ142) larger than the diameter (φ3) of the lock portion.

6. A bolt as set forth in claim 1, wherein
the fastened bolt and the fastening bolt are formed by the same material.

7. A bolt as set forth in claim 1, wherein the fastening bolt is formed by a material which is weaker than the strength of the fastened bolt.

8. A bolt comprising:
a fastened bolt which is screwed into clamped components,
a fastening bolt, and
a lock portion, wherein,
the fastened bolt is configured by a fastened bolt shank having a concave portion at the center and a first serration provided on one end of the fastened bolt shank,
the fastening bolt is configured by a fastening bolt shank which is slidably inserted into the concave portion provided in the fastened bolt shank and a second serration provided on one end of the fastening bolt shank,
the lock portion is provided in an end part of the fastening bolt shank which is positioned on the opposite side to the second serration of the fastening bolt and is configured so that the fastening bolt will not detach from the fastened bolt,
a first engagement portion is provided on the top of the first serration,
a second engagement portion is provided on a surface of the second serration which confronts (faces) the first serration, the first engagement portion and the second engagement portion are engaged only at the time when the fastening bolt is turned in one direction and thereby turns the fastened bolt in only one direction, and
wherein, when the first engagement portion and the second engagement portion are engaged and clamp the fastened bolt,
when a clamp load that turns the fastened bolt in only one direction reaches a predetermined torque, the clamp load of the fastening bolt is not transferred to the fastened bolt.

9. A bolt as set forth in claim 8, wherein:
the first engagement portion has a first abutting surface and a first inclined face,
the second engagement portion has a second abutting surface and a second inclined face,
wherein, when the fastening bolt is turned in one direction, the first abutting surface and the second abutting surface abut against each other to stop the turning of the fastening bolt in that one direction, and
wherein when the fastening bolt is turned in the other direction, the first inclined face and the second inclined face slidingly move to allow the turning of the fastening bolt in the other direction.

10. A bolt as set forth in claim 9, wherein:
engaged portions of the first engagement portion and the second engagement portion are configured shallow, and
when a clamp load that turns the fastened bolt becomes a predetermined torque or more at the engagement portions, at least a portion of the first engagement portion and/or the second engagement portion is destroyed.

11. A bolt as set forth in claim 9, wherein:
a notch or groove is provided in the engaged portions of the first engagement portion and the second engagement portion in a direction perpendicular to the fastened bolt shank, and
when a clamp load that turns the fastened bolt in only one direction becomes a predetermined torque or more, the part of the first engagement portion which is engaged with the second engagement portion is destroyed along the notch or groove or in a portion of the first engagement portion where the strength falls due to the notch or groove.

12. A bolt as set forth in claim 8, wherein the concave portion (through-hole) is configured by a bolt shank insertion hole having a diameter (φ141) such that the diameter (φ14) of the concave portion (through-hole) is larger than the diameter (φ22) of the fastening shank and smaller than the diameter (φ3) of the lock portion, and
a through-hole which connects with the bolt shank insertion hole and has a diameter (φ142) larger than the diameter (φ3) of the lock portion.

13. A bolt as set forth in claim 8, wherein
the fastened bolt and the fastening bolt are formed by the same material.

14. A bolt as set forth in claim 2, wherein the fastening bolt is formed by a material which is weaker than the strength of the fastened bolt.
